(19) United States
(12) Patent Application Publication
(10) Pub. No.: US 2025/0004668 A1
(43) Pub. Date: Jan. 2, 2025

(54) INTER-TIER METADATA STORAGE

(71) Applicant: Micron Technology, Inc., Boise, ID (US)

(72) Inventor: David Andrew Roberts, Wellesley, MA (US)

(21) Appl. No.: 18/639,716

(22) Filed: Apr. 18, 2024

Related U.S. Application Data
(60) Provisional application No. 63/510,419, filed on Jun. 27, 2023.

(51) Int. Cl. G06F 3/06; G06F 12/0862

(52) U.S. Cl. CPC G06F 3/0659; G06F 3/0604; G06F 3/0679; G06F 12/0862; G06F 2212/602

(57) ABSTRACT

Methods, systems, and devices for inter-tier metadata storage are described. A controller associated with a memory system may manage metadata storage across tiers of memory within the memory system or across memory systems. The controller may transfer metadata between tiers of memory based on whether an access count associated with the metadata satisfies a threshold. For example, the controller may transfer metadata from a first tier of memory to a second tier of memory if the access count satisfies a threshold count. The controller may transfer the metadata from the second tier of memory to the first tier of memory if the access count fails to satisfy the threshold count.

### CROSS REFERENCE

The present Application for Patent claims priority to U.S. Patent Application No. 63/510,419 by David Andrew Roberts, entitled “INTER-TIER METADATA STORAGE,” filed Jun. 27, 2023, which is assigned to the assignee hereof, and which is expressly incorporated by reference in its entirety herein.

### TECHNICAL FIELD

The following relates to one or more systems for memory, including inter-tier metadata storage.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells in a non-volatile configuration may maintain stored logic states for extended periods of time even in the absence of an external power source. Memory cells in a volatile configuration may lose stored states when disconnected from an external power source.

### BRIEF DESCRIPTION OF THE DRAWINGS

FIGS. 1 through 3 show examples of systems that support inter-tier metadata storage in accordance with examples as disclosed herein.

FIG. 4 shows a block diagram of a memory system that supports inter-tier metadata storage in accordance with examples as disclosed herein.

FIG. 5 shows a flowchart illustrating a method or methods that support inter-tier metadata storage in accordance with examples as disclosed herein.

### DETAILED DESCRIPTION

Some systems (e.g., a compute express link (CXL) system, a peripheral component interconnect express (PCIe), a system implementing a Gen-Z protocol, an Open coherent accelerator processors interface (OpenCAPI) system, an Ethernet system) may utilize metadata to support various operations of the system. For example, a system may utilize metadata to implement data prefetching, among other operations. Data prefetching may include learning from past data accesses and predicting future data accesses of a memory system and buffering (e.g., transferring, prefetching) that data to low latency memory (e.g., cache memory, volatile memory) before receiving an access request for the data, which may result in increased data access speeds and system efficiency. Metadata may support data prefetching, for example, by indicating a history of one or more previous access sequences that may be replayed in advance, such as when a start of a previously-observed sequence begins. As such, the metadata may be used to predict subsequent data accesses in accordance with the observed sequence to support prefetching the data in accordance with the predictions.

In some examples, metadata may be managed and stored on-chip, such as at a host system associated with the memory system. In some cases, however, a quantity of metadata may exceed a metadata storage capacity at the host system, and the host system may support off-chip metadata storage, such as storing the metadata at the memory system. As such, the host system may access the metadata from the memory system, but such accessing may incur heavy off-chip traffic and result in increased latency associated with communicating the metadata between the memory system and the host system. Some systems may support prefetching metadata to a host system cache to reduce latency, but in some cases, the quantity of prefetched metadata may exceed cache storage available for the metadata, thereby resulting in a limited quantity of metadata that may be prefetched to the host system cache and continued accesses of metadata at the memory system by the host system.

Additionally, storing larger quantities of metadata at the memory system may result in increased prefetching accuracy and longer latency hiding, for example, by enabling additional access sequences to be tracked and stored. However, storing large quantities of metadata in lower latency memory may be expensive, while storing metadata in higher latency memory may increase metadata access latency, thereby reducing prefetching performance.

Techniques, systems, and devices are described herein for inter-tier metadata storage within a memory system to support increased metadata storage while reducing cost and metadata access latency, among other benefits. For example, a controller associated with the memory system (e.g., a controller included in the memory system, a controller coupled with the memory system such as included in a switch used to couple the memory system and a host system) may manage the storage of metadata across one or more tiers of memory (which may be referred to as memory tiers) within the memory system or across memory systems. For instance, each memory tier may be associated with a respective (e.g., a different) access latency and/or bandwidth (among other operating parameters), where top (e.g., higher) memory tiers may be characterized by lower latencies and/or higher bandwidths and bottom (e.g., lower) tiers may be characterized by higher latencies and/or lower bandwidths. The controller may manage the metadata such that some metadata that is accessed relatively more frequently may be stored in higher memory tiers while metadata that is accessed relatively less frequently may be stored in lower memory tiers. Additionally or alternatively, metadata may be transferred (e.g., moved) between memory tiers as respective access rates (e.g., access counts, access frequencies) change. As such, the controller may promote or demote the stored metadata between the tiers such that metadata associated with higher access counts may be readily available for access (e.g., accessed with reduced latency). Further, greater quantities of metadata may be stored at reduced cost while supporting lower latency access due to storing some metadata in lower tier, less expensive, memory and transferring the metadata to higher, faster, tier memory if accessed more frequently, among other advantages.

Additionally, in some examples of prefetching, the controller may access and transfer metadata to a metadata cache included in the memory system or the switch (e.g., if the metadata is not already stored to the metadata cache) based on a request to access data associated with the metadata. The controller may use the metadata in association with prefetching additional data. As such, metadata communication may in some examples be contained between the memory tiers and the metadata cache and, in some cases, may not be communicated to the host system, thereby reducing latency associated with such communication. Additionally or alternatively, the adjustable tiering of metadata supported by the controller may reduce a latency at which metadata is transferred to the metadata cache to support prefetching.

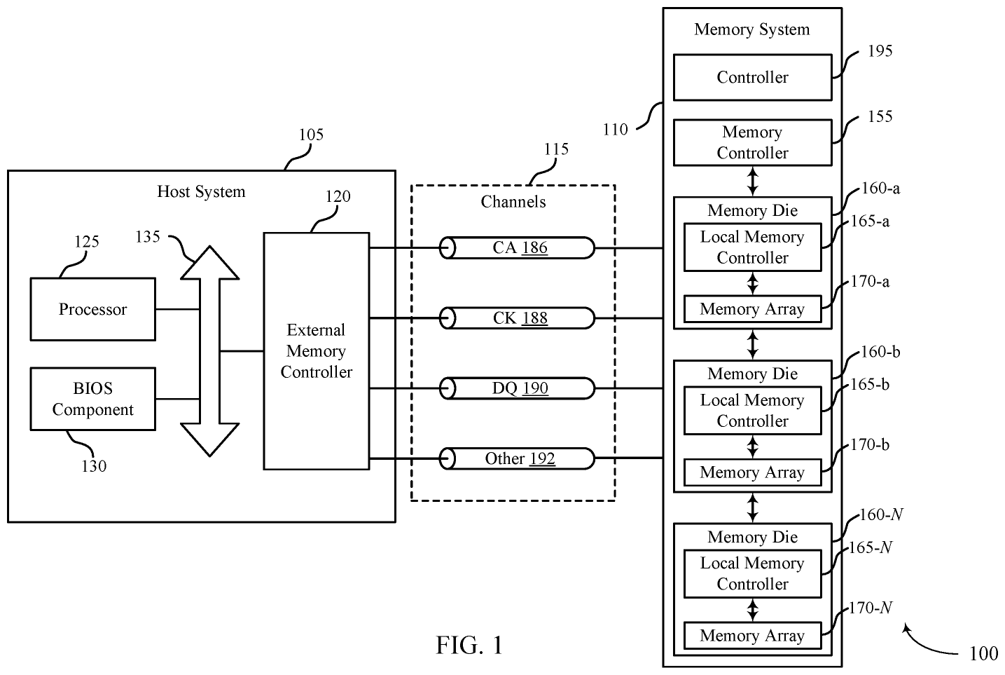

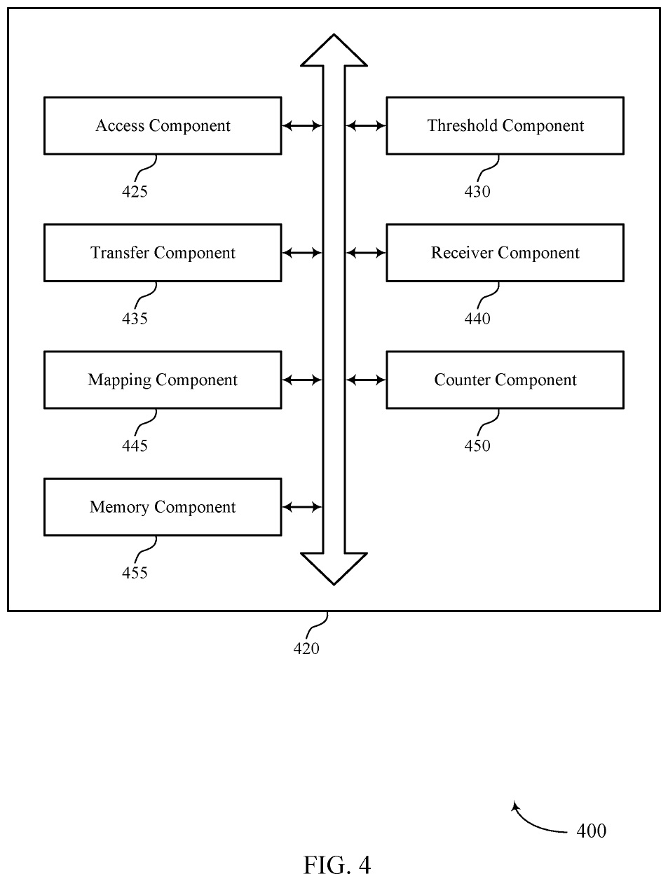

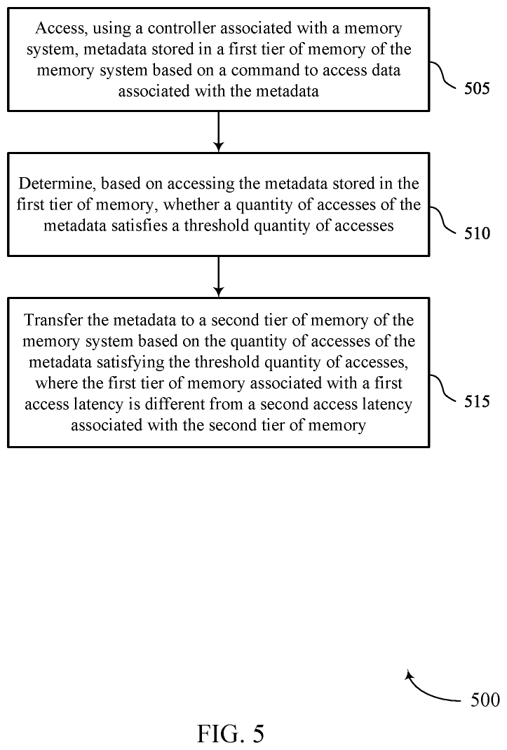

Features of the disclosure are described in the context of systems and devices as described with reference to FIGS. 1 through 3. These and other features of the disclosure are further illustrated by and described with reference to an apparatus diagram and flowcharts that relate to inter-tier metadata storage as described with reference to FIGS. 4 and 5.

FIG. 1 shows an example of a system 100 that supports inter-tier metadata storage in accordance with examples as disclosed herein. The system 100 may include a host system 105, a memory system 110, and a plurality of channels 115 coupling the host system 105 with the memory system 110. The system 100 may include one or more memory system 110, but aspects of the one or more memory systems 110 may be described in the context of a single memory system (e.g., memory system 110).

The system 100 may include portions of an electronic device, such as a computing device, a mobile computing device, a wireless device, a graphics processing device, a vehicle, or other systems. For example, the system 100 may illustrate aspects of a computer, a laptop computer, a tablet computer, a smartphone, a cellular phone, a wearable device, an internet-connected device, a vehicle controller, or the like. The memory system 110 may be a component of the system 100 that is operable to store data for one or more other components of the system 100.

Portions of the system 100 may be examples of the host system 105. The host system 105 may be an example of a processor (e.g., circuitry, processing circuitry, a processing component) within a device that uses memory to execute processes, such as within a computing device, a mobile computing device, a wireless device, a graphics processing device, a computer, a laptop computer, a tablet computer, a smartphone, a cellular phone, a wearable device, an internet-connected device, a vehicle controller, a system on a chip (SoC), or some other stationary or portable electronic device, among other examples. In some examples, the host system 105 may refer to the hardware, firmware, software, or any combination thereof that implements the functions of an external memory controller 120. In some examples, the external memory controller 120 may be referred to as a host (e.g., host system 105).

A memory system 110 may be an independent device or a component that is operable to provide physical memory addresses/space that may be used or referenced by the system 100. In some examples, a memory system 110 may be configurable to work with one or more different types of host devices. Signaling between the host system 105 and the memory system 110 may be operable to support one or more of: modulation schemes to modulate the signals, various pin configurations for communicating the signals, various form factors for physical packaging of the host system 105 and the memory system 110, clock signaling and synchronization between the host system 105 and the memory system 110, timing conventions, or other functions.

The memory system 110 may be operable to store data for the components of the host system 105. In some examples, the memory system 110 (e.g., operating as a secondary-type device to the host system 105, operating as a dependent-type device to the host system 105) may respond to and execute commands provided by the host system 105 through the external memory controller 120. Such commands may include one or more of a write command for a write operation, a read command for a read operation, a refresh command for a refresh operation, or other commands.

The host system 105 may include one or more of an external memory controller 120, a processor 125, a basic input/output system (BIOS) component 130, or other components such as one or more peripheral components or one or more input/output controllers. The components of the host system 105 may be coupled with one another using a bus 135.

The processor 125 may be operable to provide functionality (e.g., control functionality) for the system 100 or the host system 105. The processor 125 may be a general-purpose processor, a digital signal processor (DSP), an application-specific integrated circuit (ASIC), a field-programmable gate array (FPGA) or other programmable logic device, discrete gate or transistor logic, discrete hardware components, or any combination of these components. In such examples, the processor 125 may be an example of a central processing unit (CPU), a graphics processing unit (GPU), a general purpose GPU (GPGPU), or an SoC, among other examples. In some examples, the external memory controller 120 may be implemented by or be a part of the processor 125.

The BIOS component 130 may be a software component that includes a BIOS operated as firmware, which may initialize and run various hardware components of the system 100 or the host system 105. The BIOS component 130 may also manage data flow between the processor 125 and the various components of the system 100 or the host system 105. The BIOS component 130 may include instructions (e.g., a program, software) stored in one or more of read-only memory (ROM), flash memory, or other non-volatile memory.

In some examples, the system 100 or the host system 105 may include various peripheral components. The peripheral components may be any input device or output device, or an interface for such devices, that may be integrated into or with the system 100 or the host system 105. Examples may include one or more of: a disk controller, a sound controller, a graphics controller, an Ethernet controller, a modem, a universal serial bus (USB) controller, a serial or parallel port, or a peripheral card slot such as peripheral component interconnect (PCI) or specialized graphics ports. The peripheral component(s) may be other components understood by a person having ordinary skill in the art as a peripheral.

In some examples, the system 100 or the host system 105 may include an I/O controller. An I/O controller may manage data communication between the processor 125 and the peripheral component(s) (e.g., input devices, output devices). The I/O controller may manage peripherals that are not integrated into or with the system 100 or the host system 105. In some examples, the I/O controller may represent a physical connection (e.g., one or more ports) with external peripheral components.

In some examples, the system 100 or the host system 105 may include an input component, an output component, or both. An input component may represent a device or signal external to the system 100 that provides information (e.g., signals, data) to the system 100 or its components. In some examples, an input component may include an interface (e.g., a user interface or an interface between other devices). In some examples, an input component may be a peripheral that interfaces with system 100 via one or more peripheral components or may be managed by an I/O controller. An output component may represent a device or signal external to the system 100 operable to receive an output from the system 100 or any of its components. Examples of an output component may include a display, audio speakers, a printing device, another processor on a printed circuit board, and others. In some examples, an output may be a peripheral that interfaces with the system 100 via one or more peripheral components or may be managed by an I/O controller.

The memory system 110 may include a memory controller 155 and one or more memory dies 160 (e.g., memory chips) to support a capacity (e.g., a desired capacity, a specified capacity) for data storage. Each memory die 160 (e.g., memory die 160-a, memory die 160-b, memory die 160-N) may include a local memory controller 165 (e.g., local memory controller 165-a, local memory controller 165-b, local memory controller 165-N) and a memory array 170 (e.g., memory array 170-a, memory array 170-b, memory array 170-N). A memory array 170 may be a collection (e.g., one or more grids, one or more banks, one or more tiles, one or more sections) of memory cells, with each memory cell being operable to store one or more bits of data. A memory system 110 including two or more memory dies 160 may be referred to as a multi-die memory or a multi-die package or a multi-chip memory or a multi-chip package.

The memory controller 155 may include components (e.g., circuitry, logic) operable to control operation of the memory system 110. The memory controller 155 may include hardware, firmware, or instructions that enable the memory system 110 to perform various operations and may be operable to receive, transmit, or execute commands, data, or control information related to the components of the memory system 110. The memory controller 155 may be operable to communicate with one or more of the external memory controller 120, the one or more memory dies 160, or the processor 125. In some examples, the memory controller 155 may control operation of the memory system 110 described herein in conjunction with the local memory controller 165 of the memory die 160.

In some examples, the memory system 110 may communicate information (e.g., data, commands, or both) with the host system 105. For example, the memory system 110 may receive a write command indicating that the memory system 110 is to store data received from the host system 105, or receive a read command indicating that the memory system 110 is to provide data stored in a memory die 160 to the host system 105, among other types of information communication.

A local memory controller 165 (e.g., local to a memory die 160) may include components (e.g., circuitry, logic) operable to control operation of the memory die 160. In some examples, a local memory controller 165 may be operable to communicate (e.g., receive or transmit data or commands or both) with the memory controller 155. In some examples, a memory system 110 may not include a memory controller 155, and a local memory controller 165 or the external memory controller 120 may perform various functions described herein. As such, a local memory controller 165 may be operable to communicate with the memory controller 155, with other local memory controllers 165, or directly with the external memory controller 120, or the processor 125, or any combination thereof. Examples of components that may be included in the memory controller 155 or the local memory controllers 165 or both may include receivers for receiving signals (e.g., from the external memory controller 120), transmitters for transmitting signals (e.g., to the external memory controller 120), decoders for decoding or demodulating received signals, encoders for encoding or modulating signals to be transmitted, or various other components operable for supporting described operations of the memory controller 155 or local memory controller 165 or both.

The external memory controller 120 may be operable to enable communication of information (e.g., data, commands, or both) between components of the system 100 (e.g., between components of the host system 105, such as the processor 125, and the memory system 110). The external memory controller 120 may process (e.g., convert, translate) communications exchanged between the components of the host system 105 and the memory system 110. In some examples, the external memory controller 120, or other component of the system 100 or the host system 105, or its functions described herein, may be implemented by the processor 125. For example, the external memory controller 120 may be hardware, firmware, or software, or some combination thereof implemented by the processor 125 or other component of the system 100 or the host system 105. Although the external memory controller 120 is depicted as being external to the memory system 110, in some examples, the external memory controller 120, or its functions described herein, may be implemented by one or more components of a memory system 110 (e.g., a memory controller 155, a local memory controller 165) or vice versa.

The components of the host system 105 may exchange information with the memory system 110 using one or more channels 115. The channels 115 may be operable to support communications between the external memory controller 120 and the memory system 110. Each channel 115 may be an example of a transmission medium that carries information between the host system 105 and the memory system 110. Each channel 115 may include one or more signal paths (e.g., a transmission medium, a conductor) between terminals associated with the components of the system 100. A signal path may be an example of a conductive path operable to carry a signal. For example, a channel 115 may be associated with a first terminal (e.g., including one or more pins, including one or more pads) at the host system 105 and a second terminal at the memory system 110. A terminal may be an example of a conductive input or output point of a device of the system 100, and a terminal may be operable to act as part of a channel.

Channels 115 (and associated signal paths and terminals) may be dedicated to communicating one or more types of information. For example, the channels 115 may include one or more command and address (CA) channels 186, one or more clock signal (CK) channels 188, one or more data (DQ) channels 190, one or more other channels 192, or any combination thereof. In some examples, signaling may be communicated over the channels 115 using single data rate (SDR) signaling or double data rate (DDR) signaling. In SDR signaling, one modulation symbol (e.g., signal level) of a signal may be registered for each clock cycle (e.g., on a rising or falling edge of a clock signal). In DDR signaling, two modulation symbols (e.g., signal levels) of a signal may be registered for each clock cycle (e.g., on both a rising edge and a falling edge of a clock signal).

In some examples, CA channels 186 may be operable to communicate commands between the host system 105 and the memory system 110 including control information associated with the commands (e.g., address information). For example, commands carried by the CA channel 186 may include a read command with an address of the desired data. In some examples, a CA channel 186 may include any quantity of signal paths (e.g., eight or nine signal paths) to communicate control information (e.g., commands or addresses).

In some examples, data channels 190 may be operable to communicate information (e.g., data, control information) between the host system 105 and the memory system 110. For example, the data channels 190 may communicate information (e.g., bi-directional) to be written to the memory system 110 or information read from the memory system 110.

In some examples, metadata may be managed and stored at the host system. In some cases, however, a quantity of metadata may exceed metadata storage capacity at the host system 105, and the host system 105 may support off-chip metadata storage, such as storing the metadata at the memory system 110. As such, the host system 105 may access the metadata from the memory system 110, but such accessing may incur heavy off-chip traffic and result in increased latency associated with communicating the metadata between the memory system 110 and the host system 105. Some systems may support prefetching metadata to a cache of the host system 105 (e.g., to a processor 125, to an external memory controller 120) to reduce latency but, in some cases, the quantity of prefetched metadata may exceed cache storage available for the metadata at the host system 105, thereby resulting in a limited quantity of metadata that may be prefetched to the cache of the host system 105 and continued accesses of metadata at the memory system 110 by the host system 105.

Additionally, storing larger quantities of metadata at the memory system 110 may result in increased prefetching accuracy and longer latency hiding, for example, by enabling additional access sequences to be tracked and stored. However, storing large quantities of metadata in lower latency memory may be expensive, while storing metadata in higher latency memory may increase metadata access latency, thereby reducing prefetching performance.

Techniques, systems, and devices are described herein for inter-tier metadata storage within the memory system 110 to support increased metadata storage while reducing cost and metadata access latency, among other benefits. For example, a controller 195 associated with the memory system 110 may manage the storage of metadata across memory tiers within the memory system 110 or across memory systems 110. For instance, each memory tier (e.g., different memory dies 160, different memory arrays 170) may be associated with a respective (e.g., a different) access latency and/or bandwidth (among other operating parameters). The controller 195 may manage (e.g., control, facilitate) the storage of metadata such that metadata that is accessed more frequently may be stored in higher memory tiers while metadata that is accessed relatively less frequently may be stored in lower memory tiers. Additionally, metadata may be transferred (e.g., moved) between memory tiers as respective access rates (e.g., access counts, access frequencies) change. To support such adjustable metadata tiering, the controller 195 may track respective access counts (e.g., respective quantities of accesses) of respective metadata and transfer the metadata between memory tiers based on whether a respective access count satisfies a respective threshold access count.

Additionally, in some examples of prefetching, the controller 195 may access and transfer metadata to a metadata cache included in the memory system or the switch (e.g., if the metadata is not already stored to the metadata cache) based on a request to access data associated with the metadata received from the host system 105. The controller 195 may use the metadata in association with prefetching additional data, such as to the host system 105. As such, metadata communication may be contained between the memory tiers and the metadata cache and, in some cases, may not be communicated to the host system 105, thereby reducing latency associated with such communication. Additionally, the adjustable tiering of metadata supported by the controller 195 may reduce a latency at which metadata is transferred to the metadata cache to support prefetching.

In some examples, the controller 195 may be included in the memory system 110, as depicted in the example of FIG. 1. In some other examples, the controller 195 may be included in a switch, such as a switch configured to selectively couple the memory system 110 and the host system 105.

In addition to applicability in memory systems as described herein, techniques for inter-tier metadata storage may be generally implemented to support artificial intelligence applications. As the use of artificial intelligence increases to support machine learning, analytics, decision making, or other related applications, electronic devices that support artificial intelligence applications and processes may be desired. For example, artificial intelligence applications may be associated with accessing relatively large quantities of data for analytical purposes and may benefit from memory devices capable of effectively and efficiently storing relatively large quantities of data or accessing stored data relatively quickly. Implementing the techniques described herein may support artificial intelligence and/or machine learning techniques by supporting increased data prefetching accuracy, increased quantities of metadata storage while reducing cost and metadata access latency, and improving memory access speeds, among other benefits.

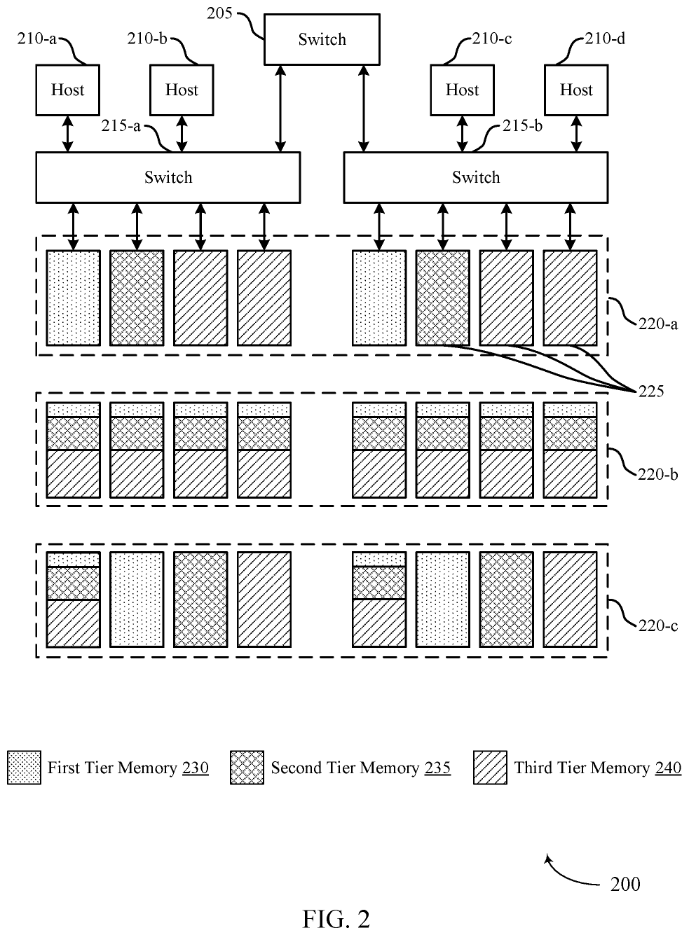

FIG. 2 shows an example of a system 200 that supports inter-tier metadata storage in accordance with examples as disclosed herein. The system 200 may include an example of the system 100 described with reference to FIG. 1. For example, the system 200 may include one or more hosts 210 that may be examples of a host system 105, and may also include one or more memory systems 225 (e.g., memory modules) that may be examples of a memory system 110, as described with reference to FIG. 1.

The system 200 may also include a switch 205 and one or more switches 215. The switches 215 may be used to selectively couple a host 210 with a memory system 225. For example, the switch 215-a may selective couple a host 210-a and a host 210-b to one or more of the memory systems 225, and the switch 215-b may selectively couple a host 210-c and a host 210-d to one or more of the memory systems 225. In some examples, the switch 205 may facilitate (e.g., determine) the coupling of the hosts 210 and the memory systems 225 via respective switches 215, such as by indicating to a respective switch 215 which host 210 is to be coupled with a corresponding memory system 225. In some examples, the system 200 may exclude the switch 205, and the switches 215 may determine which memory system(s) 225 to couple with respective hosts 210. In some examples, the switch 205 and the one or more switches 215 may be respective examples of a CXL switch, a PCIe switch, a Gen-Z switch, an OpenCAPI switch, or an Ethernet switch, among other types of switches that support selectively coupling hosts 210 (e.g., on-chip processors) to memory systems 225 (e.g., off-chip storage).

The system 200 may include one or more of the memory systems 225. In some examples, each of the memory systems 225, the switch 205, or a switch 215 may include a respective controller (e.g., a prefetch controller) and a metadata cache. The controller may support (e.g., control, facilitate, perform) prefetching data stored within each respective memory system of the memory systems 225 to one or more of the associated hosts 210 utilizing metadata stored within the metadata cache. In some examples, the controller may learn data accesses requested by one or more of the hosts 210 (e.g., store metadata indicating the data accesses) to predict future data accesses. Thus, the controller may utilize metadata associated with the data to prefetch data associated with the future accesses to the one or more hosts 210, move the data associated with the future accesses to a memory tier of higher performance, or a combination thereof, before receiving a command from one of the hosts 210 to access the future data.

In some systems 200, metadata may be cached to a host 210, which may utilize the metadata to support prefetching. However, for large scale-out systems 200 (e.g., systems operable to store relatively large quantities of data), the hosts 210 may include insufficient storage for the controller to cache (e.g., prefetch) the metadata for prefetching. That is, even if some cache capacity at a host 210 is sacrificed for metadata, metadata sufficient (e.g., desired) to support accurate prefetching may still exceed the available cache capacity of the host 210. Accordingly, the controller may instead store the metadata larger capacity memory of the memory systems 225 and access the metadata stored in the memory systems 225 to cache (e.g., transfer) the metadata in the metadata cache to support prefetching by the controller. As such, large quantities of metadata may be stored and utilized without transferring metadata between the memory systems 225 and the hosts 210, which may enable increased prefetcher accuracy and system performance and longer latency hiding associated with prefetching.

Each of the memory systems 225 may include one or more memory tiers (e.g., types of memory). To support the storage of a large quantity of metadata, memory tiers may be utilized to split and manage metadata placement within each of the memory systems 225 (e.g., rather than on the hosts 210). For example, each of the memory tiers may be used to store metadata or other data, and may each be characterized by a latency, a bandwidth, a storage quantity, a cost, or a combination thereof, among characteristics. For instance, the memory systems 225 may include one or more of the first tier memory 230, which may include the lowest latency and/or highest bandwidth (e.g., and highest cost) memory of the memory tiers. The memory systems 225 may include one or more of the third tier memory 240, which may be associated with the highest latency and/or lowest bandwidth (e.g., and lowest cost) memory of the memory tiers. The memory systems 225 may also include one or more of the second tier memory 235, which may include higher latency and/or lower bandwidth (e.g., and lower cost) memory relative to the first tier memory 230, and lower latency and/or higher bandwidth (e.g., and higher cost) memory relative to the third tier memory 240. In some cases, the memory systems 225 may include additional or fewer tiers of memory than the tiers of memory 230, 245, and 240. Memory tiers of the memory systems 225 may include various types of volatile memory, non-volatile memory, DRAM, NAND, or other types of memory, and may also be associated with varying latencies, bandwidths, and associated costs. In some examples, each tier of the memory systems 225 may be an example of a memory die 160 or a memory array 170, as discussed with reference to FIG. 1.

The system 200 may include one or more of the memory tier configurations 220. For example, the system 200 may include one or more memory tier configurations 220-a, one or more memory tier configurations 220-b, one or more memory tier configurations 220-c, or any combination thereof. The memory tier configuration 220-a may include the first tier memory 230, the second tier memory 235, and the third tier memory 240 included in separate memory systems of the memory systems 225. That is, each of the memory systems 225 in the memory tier configuration 220-a may include a single type of tiered memory of the first tier memory 230, the second tier memory 235, and the third tier memory 240 (e.g., or some other tier of memory).

The system 200 may additionally or alternatively include the memory tier configuration 220-b. The memory tier configuration 220-b may include the first tier memory 230, the second tier memory 235, and the third tier memory 240 distributed across the memory systems 225 of the memory tier configuration 220-b such that each of the memory systems 225 may include a portion of the various tiered memory. That is, each of the memory systems 225 in the memory tier configuration 220-b may include each type of tiered memory of the first tier memory 230, the second tier memory 235, and the third tier memory 240.

The system 200 may additionally or alternatively include the memory tier configuration 220-c. The memory tier configuration 220-c may include the first tier memory 230, the second tier memory 235, and the third tier memory 240 included in various combinations across the memory systems 225. That is, one or more of the memory systems 225 in the memory tier configuration 220-c may include one of the first tier memory 230, the second tier memory 235, or the third tier memory 240 (e.g., a single type of tiered memory), while one or more of the memory systems 225 may include a combination of one or more of the first tier memory 230, the second tier memory 235, and the third tier memory 240. In other words, the memory tier configuration 220-c may include a mixture of memory systems 225 included in the memory tier configurations 220-a and 220-b. Each of the memory tier configurations 220 included in the system 200 may be coupled with one or more of the switches 215. In some examples, memory systems 225 of different memory tier configurations 220 may be coupled with each other.

In some examples, metadata may be stored in one or more of the first tier memory 230, the second tier memory 235, and the third tier memory 240 of the memory systems 225 and may be managed by one or more controllers. For example, similar to how data may be stored in the tiered memory of the memory systems 225, metadata may also be stored in the tiered memory of the memory systems 225. In some examples, the controller of a respective memory system 225 that includes two or more tiers of memory may manage the stored metadata of the first tier memory 230, the second tier memory 235, the third tier memory 240, or the combination thereof. For example, the controller may rearrange previously-stored metadata of the tiered memory such that respective metadata with the higher quantities of accesses may be located in the first tier memory 230 (e.g., the fastest, highest bandwidth, highest-costing memory), while respective the metadata with lower quantities of accesses may be stored in the second tier memory 235 or the third tier memory 240. In some examples, a controller may be placed in one of the switches 215 or in the switch 205. The controller, in this case, may manage metadata between one or more of the memory systems 225 of one or more of the memory tier configurations 220. For example, a controller located in the switch 215-b may transfer metadata between memory tiers, which may include transferring the metadata from one memory system 225 to another memory system 225.

Tiering and caching metadata without transfer to a host 210 (e.g., within the memory systems 225) may allow for utilization of the large quantity of memory that may be available in the memory systems 225, which may increase prefetch accuracy and system performance and enable longer latencies associated with accessing data from higher latency memory to be hidden. For example, storing the metadata within the memory systems 225 may allow for a decrease in latency by enabling the prefetcher to identify access patterns, such as that may have occurred many microseconds in the past. Additionally, distributing the metadata across the tiered memory may prevent the first tier memory 230 from becoming overburdened with metadata, which may result in increased performance of the system 200 and/or cost savings by supporting a reduced quantity of first tier memory 230. Further, distributing the metadata across the tiered memory of the memory systems 225 may allow the storing of large quantities of metadata, which may result in easier identifying of access patterns, a decrease in latency, an increase in prefetch accuracy, among other benefits.

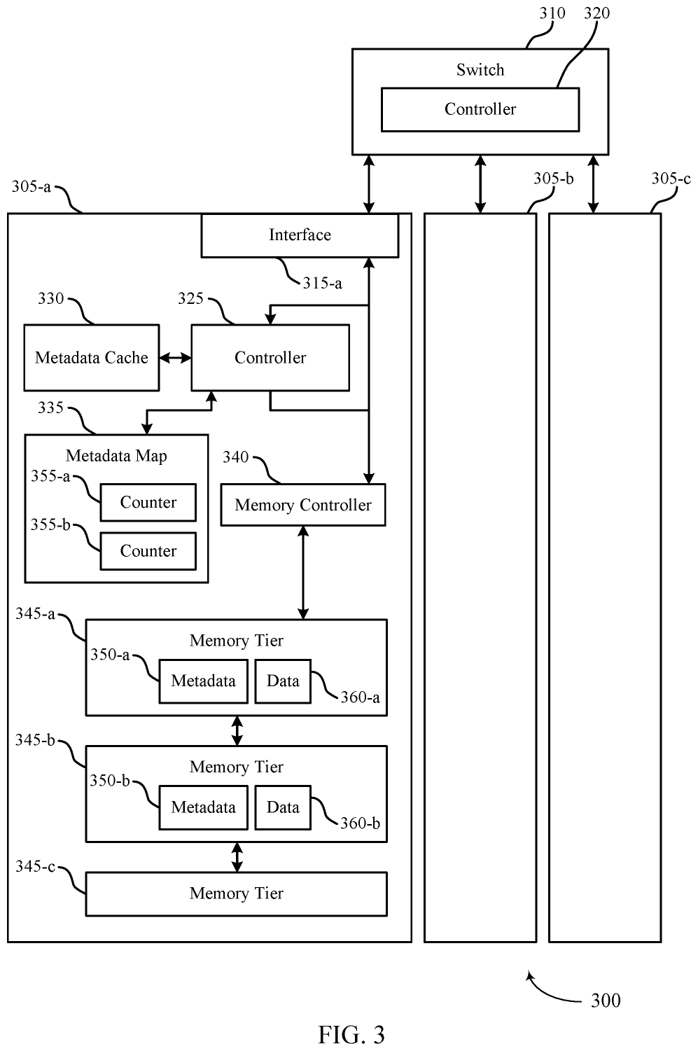

FIG. 3 shows an example of a system 300 that supports inter-tier metadata storage in accordance with examples as disclosed herein. The system 300 may be an example of a system 100 or a system 200 described with reference to FIGS. 1 and 2. For example, the system 300 may include one or more switches 310 that may be examples of a switch 215 or a switch 205 as described with reference to FIG. 2. The system 300 may also include one or more memory systems 305 (e.g., memory modules) that may be examples of memory systems 225 or a memory system 110, as described with reference to FIGS. 1 and 2. Each of the memory systems 305 (e.g., memory system 305-a, memory system 305-b, memory system 305-c) of the system 300 may include one or more memory tiers 345 which may be examples of a first tier memory 230, a second tier memory 235, a third tier memory 240, or a memory die 160 as described with reference to FIGS. 1 and 2. The memory systems 305 may also include a controller 325, a metadata cache 330, a metadata map 335, one or more counters 355, and a memory controller 340. In some cases, the controller 325 may be an example of a prefetch controller (e.g., a prefetcher). In some examples, the metadata map 335 may include the counters 355. In other examples, the counters 355 may be included (e.g., maintained) elsewhere in the memory systems 305. The memory systems 305 may also include an interface 315, which may be an example of a CXL interface, a PCIe interface, an interface implementing a Gen-Z protocol, an OpenCAPI, an Ethernet interface, or another interface.

An interface 315 may be coupled with one or more components of an associated memory system 305 and facilitate communications between the memory system 305 and devices external to the memory system 305 (e.g., the switch 310, a host 210). For example, the interface 315-a of the memory system 305-a may be coupled with the switch 310, the controller 325, and the memory controller 340. The interface 315-a may assist in facilitating transfers of commands, data 360, and metadata 350 between the various components of the system 300. For example, the interface 315-a may assist in facilitating the communication of information (e.g., the data 360, the metadata 350) and commands between the switch 310 (e.g., a controller 320 of the switch 310) and the controller 325, the memory controller 340, or both.

A memory system 305 may also include a controller 325 and a metadata cache 330. For example, the memory system 305-a may include the controller 325 that may distribute and manage the metadata 350 (e.g., and the data 360). Additionally, the memory system 305-a may include the metadata cache 330 that may store the metadata 350 accessed by (e.g., prefetched by) the controller 325. For example, the controller 325 may receive (e.g., snoop) incoming commands from the switch 310 (e.g., via the interface 315-a) and may access the metadata 350 (e.g., previously-prefetched metadata, metadata previously transferred to) stored in the metadata cache 330. Alternatively, if the metadata 350 is not included in the metadata cache 330, the controller 325 may transfer the metadata 350 to the metadata cache from an associated memory tier 345. The controller 325 may utilize a portion of the metadata 350 stored in the metadata cache 330 to prefetch future data 360 that may be requested by a host (e.g., a host 210). To prefetch the data 360, the controller 325 may access the data 360 associated with the stored metadata 350 via the memory controller 340 (e.g., or using a data mover component), which may assist in facilitating the communication of the data 360 via the interface 315-a. The controller 325 may manage the storage of metadata 350 within the memory tiers 345 (e.g., via the memory controller 340 or the data mover component). For example, the controller 325 (e.g., via the memory controller 340, via a data mover) may move metadata 350 between the memory tiers 345, move respective metadata 350 to the metadata cache 330, or both.

If moving metadata 350 between memory tiers 345, the controller 325 may update the metadata map 335 with the new location of the metadata 350 within the memory tiers 345. For example, the metadata map 335 may store a mapping indicating a location of respective metadata 350 within the respective memory system 305. In some examples, the mapping may be a logical-to-physical (L2P) mapping of respective metadata 350 and the physical location of the respective metadata 350 within the memory system 305-a (e.g., a respective memory tier 345). In some examples, the metadata map 335 may be included in a reserved portion of memory within the memory system 305-a. In some examples, the metadata map 335 may be structured as a page table with multiple entries that each include a respective mapping of respective metadata 350, a radix tree, a hash table, or some other structure. The controller 325 may access the metadata map 335 to support accessing metadata 350 and transferring the metadata 350 to the metadata cache 330. For example, if the metadata cache 330 excludes (e.g., does not currently store) metadata 350 associated with requested data 360, the controller 325 may access the metadata map 335 to determine the location of the metadata 350 (e.g., the physical address of the metadata 350 within a given memory tier 345) and transfer the metadata 350 to the metadata cache 330.

In some examples, each entry of the metadata map 335 may be associated with (e.g., include) a counter 355. Each of the counters 355 may be associated with respective metadata 350 (e.g., metadata 350-a, metadata 350-b) and may count accesses (e.g., by the controller 325, by the memory controller 340) of the associated metadata 350. For example, the counter 355-a of the metadata map 335 may count each access operation associated with the metadata 350-a (e.g., currently stored in the memory tier 345-a). In some cases, the counter 355-a may also count accesses to the metadata 350-a when the metadata 350-a may be located in the metadata cache 330.

The controller 325 may be responsible for managing the counters 355 and the values thereof. For example, the controller 325 may increment the values of the counters 355 on each access of the associated metadata 350. Along with incrementing the values of the counters 355 on each access, the controller 325 may decrement, reset, or divide the values of each of the counters 355 on various accesses, periodically, in response to a command from a host system via the switch 310 or from the memory system 305-a.

In some examples, a prefetch policy associated with the system 300 may define a threshold quantity of access counts (e.g., associated with the values the counters 355) for transferring the metadata 350 between the memory tiers 345. For example, there may be a first threshold quantity of accesses (e.g., a threshold access count) associated with moving the metadata 350 between the memory tier 345-a and the memory tier 345-b, and a second threshold access count associated with moving the metadata 350 between the memory tier 345-b and the memory tier 345-c, and so on. As such, there may be N−1 thresholds for N memory tiers 345 (e.g., within each memory system 305, across memory systems 305, such as if one or more memory systems 305 include a single memory tier 345).

Each memory system of the memory systems 305 may also include one or more of the memory tiers 345. For example, the memory system 305-a may include the memory tier 345-a, the memory tier 345-b, and the memory tier 345-c, which may be examples of the memory tiers 230, 235, and 240, respectively. In some examples, the memory systems 305 may include different configurations of the memory tiers 345 (e.g., as discussed with reference to FIG. 2).

The controller 325 may move the metadata 350 stored in one or more of the memory tiers 345 between the memory tiers 345. In some examples, the controller 325 may move the metadata 350 stored in the memory tiers 345 between the memory tiers 345 based on whether respective values of the counters 355 associated with the metadata 350 satisfy one or more of the threshold access count. For example, the controller 325 may determine that the value of the counter 355-b associated with accessing the metadata 350-b may satisfy (e.g., meet or exceed) the threshold associated with moving the metadata 350 between the memory tier 345-a and the memory tier 345-b. In response to the access count of the counter 355-b satisfying this threshold, the controller 325 may transfer (e.g., via the memory controller 340) the metadata 350-b from the memory tier 345-b to the memory tier 345-a.

By promoting the metadata 350-b to a memory tier 345 associated a higher bandwidth and/or lower latency (e.g., memory tier 345-a), the controller 325 may enable easier access to frequently-accessed metadata 350 (e.g., the metadata 350-b), which may result in increased access speeds and system efficiency, among other benefits. In some other examples, the controller 325 may access the metadata 350-a stored in the memory tier 345-a, and may determine that the value of the counter 355-a associated with accessing the metadata 350-a may fail to satisfy (e.g., be less than, be less than or equal to) the threshold associated with moving the metadata 350 between the memory tier 345-a and the memory tier 345-b. As such, the controller 325 may transfer the metadata 350-a from the memory tier 345-a to the memory tier 345-b. By demoting the metadata 350-a to a memory tier including a lower bandwidth and higher latency (e.g., memory tier 345-b), the controller 325 may free up fast, expensive memory for the storage of frequently-accessed metadata 350. In this way, the controller 325 may attempt to distribute metadata 350 to tradeoff between latency to load (e.g., transfer) the metadata to the metadata cache 330 and capacity consumed in expensive higher tier memory.

In some examples, the controller 325 may promote or demote the metadata 350 by one memory tier 345 at a time. For example, the controller 325 may not promote the metadata 350 directly between the memory tier 345-c and the memory tier 345-a. In some examples, the controller 325 may demote metadata 350 by more than memory tier 345 at a time. For example, if a counter 355 associated with the metadata 350 is reset, the controller 325 may demote the metadata 350 by one or more memory tiers 345 (e.g., to a lowest memory tier 345, such as the memory tier 345-c).

In some examples, the controller 325 may include or be coupled with a data mover to facilitate the migration of the metadata between the memory tiers 345. For example, the data mover may be an example of a standard IP block that may include one or more data copy engines. In some examples, the data copy engines of the data mover may enable concurrent copying (e.g., transfers) of data 360 or the metadata 350 between the memory tiers 345, between the components of the memory system 305-a, between the memory systems 305, between the switch 310 and the memory systems, or a combination thereof.

In some examples, a host system (e.g., a host 210) may transmit an access command, and the controller 325 may initiate a prefetch policy. For example, the host system may determine that a cache of the host system may not store desired data 360 (e.g., data 360-a), and may send an access command to the controller 325 via the interface 315-a (e.g., via the switch 310) to access the data 360-a. Based on (e.g., in response to) the access command, the controller 325 may invoke a prefetch policy. That is, the controller 325 may access the metadata cache 330 to determine whether metadata 350 associated with the received command (e.g., associated with the data 360-a requested by the command) is stored in the metadata cache 330. For example, the metadata 350-b may be metadata associated with the data 360-a that enables the controller 325 to prefetch additional data (e.g., data 360-b) based on the data 360-a being accessed. In the case that the metadata 350-b is stored within the metadata cache 330, the controller 325 may utilize the stored metadata 350-b to prefetch the additional data (e.g., the data 360-b) to the host system or a cache of the memory system 305-a or to transfer (e.g., promote) the additional data 360 to a higher memory tier 345 (e.g., transfer the data 360-b from the memory tier 345-b to the memory tier 345-a) such that the additional data 360 may be accessed with reduced latency. In some examples, the controller 325 may also increment a counter 355 associated with the metadata 350-b.

If the metadata 350 is not stored within the metadata cache 330, the controller 325 may move (e.g., prefetch) at least a portion of the metadata 350 to the metadata cache 330. Here, the controller 325 may access the metadata map 335. For example, in response to determining that the metadata cache 330 does not store the metadata 350-b associated with the received command, the controller 325 may access the metadata map 335 to determine the location of the metadata 350-b within the memory tiers 345. For example, the controller 325 may access the metadata map 335 to determine, via a corresponding mapping of the metadata map 335, the location of the metadata 350-b to be in the memory tier 345-b.

The controller 325 may utilize the mapping accessed in the metadata map 335 to access the desired metadata 350-b (e.g., via the memory controller 340) and transfer the metadata 350-b to the metadata cache 330. That is, the controller 325 may transmit the address associated with the accessed mapping (e.g., associated with the memory tier 345-b) to the memory controller 340, and the memory controller 340 may retrieve the metadata 350-b. The controller 325 may cache the accessed metadata 350-b in the metadata cache 330 and may increment the value of the counter 355-b associated with the metadata 350-b to reflect the access. The controller 325 may use the metadata 350-b to prefetch the additional data 360 (e.g., the data 360-b) to the host system or a cache of the memory system 305-a or to transfer (e.g., promote) the additional data 360 to a higher memory tier 345 (e.g., the memory tier 345-a).

In some examples, the controller 325 may initiate promotion of the metadata 350-b based on accessing the metadata 350-b (e.g., in the memory tier 345-b, in the metadata cache 330). For example, the controller 325 may determine the updated value of the counter 355-b satisfies the threshold access count (e.g., indicated by the prefetch policy) associated with moving the metadata 350 between the memory tier 345-a and the memory tier 345-b. The controller 325 may then, via the memory controller 340 or the data mover component, promote (e.g., move up one tier, transfer) the metadata 350-b from the memory tier 345-b to the memory tier 345-a. Such promotion may enable the controller 325 to access and transfer the metadata 350-b to the metadata cache 330 more quickly in the future relative to if the metadata 350-b remained in the memory tier 345-b.

In some examples, the controller 325 may demote metadata 350, such as based on adjusting a value of one or more counters 355. For example, the host system may transmit a command to the controller 325 that indicates for the controller 325 to reset (e.g., to zero), divide (e.g., by two, among other divisors), or decrement (e.g., by a value of one or more) respective values of one or more counters 355. In some examples, the command may indicate a range of metadata 350 (e.g., logical addresses associated with the metadata 350 or data 360) for which corresponding counters 355 are to have their values adjusted. Alternatively, the controller 325 may be configured to periodically reset, divide, or decrement respective values of one or more counters 355. Due to the adjustment of the values of the one or more counters 355, corresponding metadata 350 may be demoted by the controller 325. For example, after adjusting the value of a counter 355-a associated with the metadata 350-a, the controller 325 may determine that the adjusted value of the counter 355-a fails to satisfy the threshold access count associated with moving the metadata 350 between the memory tier 345-a and the memory tier 345-b. As such, the controller 325 may demote (e.g., move down one tier, transfer) the metadata 350-a from the memory tier 345-a to the memory tier 345-b, such as to free up the memory tier 345-a for metadata 350 that be associated with higher access counts. In some examples, the controller 325 may check the values of the counters 355 for demotion in response to adjusting the values. In some examples, the controller 325 may check the values of the counters 355 after respective subsequent accesses of the respective metadata 350.

In some examples, a controller 320 (e.g., a prefetcher, a data mover) of the switch 310 may facilitate the tiering of the metadata 350, such as between the memory systems 305 or within a given memory system 305. That is, operations of the controller 325 may be implemented by the controller 320 to support the tiering of metadata 350. For example, the controller 320 may move (e.g., promote, demote, transfer) metadata 350 between the memory system 305-a, the memory system 305-b, the memory system 305-c, or a combination thereof. For example, the controller 320 may receive a command (e.g., from the host system) to access data 360 stored in one of the memory systems 305. The controller 320 may access metadata 350 associated with the data 360, such as located in a memory tier 345 of the memory system 305-b, and may move the metadata 350 to a memory tier 345 of the memory system 305-a, for example, in accordance with a threshold access count associated with transferring metadata 350 between the memory tiers 345. The controller 320 may also support the demotion of metadata 350 between memory tiers 345 of respective memory systems 305 in accordance with the techniques described herein.

In some examples, the switch 310 (e.g., the controller 320) may forward addresses targeted to other memory systems 305 to a memory system 305-a performing the tiered prefetch function. For example, if the memory system 305-a supports tiered metadata storage, the controller 320 may transmit a command to access metadata 350 stored in the memory system 305-b to the memory system 305-a. The controller 325 may access the metadata 350 stored in the memory system 305-b such that the metadata 350 may be subsequently tiered within the memory tiers 345 of the memory system 305-a.

Utilization of the managed memory tiers 345 within one or more of the memory systems 305 may result in increased prefetch accuracy, more efficient use of higher latency memories, decreased overhead, and the ability to store large quantities of metadata, among other benefits.

FIG. 4 shows a block diagram 400 of a system 420 that supports inter-tier metadata storage in accordance with examples as disclosed herein. The system 420 may be an example of aspects of system (e.g., a memory system, a system that includes one or more memory systems) as described with reference to FIGS. 1 through 3. The system 420, or various components thereof, may be an example of means for performing various aspects of inter-tier metadata storage as described herein. For example, the system 420 may include an access component 425, a threshold component 430, a transfer component 435, a receiver component 440, a mapping component 445, a counter component 450, a memory component 455, or any combination thereof. Each of these components may communicate, directly or indirectly, with one another (e.g., via one or more buses).

The access component 425 may be configured as or otherwise support a means for accessing, using a controller associated with a memory system, metadata stored in a first tier of memory of the memory system based on a command to access data associated with the metadata. The threshold component 430 may be configured as or otherwise support a means for determining, based on accessing the metadata stored in the first tier of memory, whether a quantity of accesses of the metadata satisfies a threshold quantity of accesses. The transfer component 435 may be configured as or otherwise support a means for transferring the metadata to a second tier of memory of the memory system based on the quantity of accesses of the metadata satisfying the threshold quantity of accesses, where the first tier of memory associated with a first access latency is different from a second access latency associated with the second tier of memory.

In some examples, the receiver component 440 may be configured as or otherwise support a means for receiving the command to access the data. In some examples, the mapping component 445 may be configured as or otherwise support a means for accessing, based on the metadata being excluded from a metadata cache of the memory system, a metadata mapping indicating a location of the metadata within the memory system, where accessing the metadata stored in the first tier of memory of the memory system is based on accessing the metadata mapping.

In some examples, the mapping component 445 may be configured as or otherwise support a means for updating the metadata mapping to indicate a second location of the metadata within the second tier of memory based on transferring the metadata to the second tier of memory.

In some examples, to support accessing the metadata, the access component 425 may be configured as or otherwise support a means for reading the metadata to the metadata cache in accordance with a prefetch policy associated with the controller, where the threshold quantity of accesses is defined by the prefetch policy.

In some examples, the counter component 450 may be configured as or otherwise support a means for adjusting, based on accessing the metadata, a value of a counter that tracks the quantity of accesses of the metadata, where the metadata is transferred to the second tier of memory based on the value of the counter satisfying the threshold quantity of accesses.

In some examples, a respective counter is maintained for each entry of a metadata mapping indicating respective locations of respective metadata within the memory system.

In some examples, the access component 425 may be configured as or otherwise support a means for accessing, using the controller associated with the memory system, second metadata stored in a first tier of memory of a second memory system based on a command to access second data associated with the second metadata.

In some examples, the threshold component 430 may be configured as or otherwise support a means for determining that a second quantity of accesses of second metadata stored in the first tier of memory fails to satisfy a second threshold quantity of accesses. In some examples, the transfer component 435 may be configured as or otherwise support a means for transferring the second metadata to a third tier of memory of the memory system based on the second quantity of accesses of the second metadata failing to satisfy the second threshold quantity of accesses.

In some examples, the counter component 450 may be configured as or otherwise support a means for adjusting a value of a counter that tracks the quantity of accesses of the metadata. In some examples, the transfer component 435 may be configured as or otherwise support a means for transferring the metadata from the first tier of memory to the second tier of memory or a third tier of memory of the memory system based on the adjusted value of the counter failing to satisfy the threshold quantity of accesses or a second threshold quantity of access.

In some examples, the receiver component 440 may be configured as or otherwise support a means for receiving, from a host system, a second command to adjust the value of the counter, where the value of the counter is adjusted based on the second command.

In some examples, the value of the counter is adjusted periodically.

In some examples, the value of the counter is adjusted by resetting the value of the counter, dividing the value of the counter by a second value, or decrementing the counter by a third value.

In some examples, the controller is included in a switch associated with the memory system. In some examples, the controller is included in the memory system.

In some examples, a prefetch policy defines a plurality of a threshold quantity of accesses associated with transferring respective metadata between a plurality of tiers of memory of the memory system. In some examples, the threshold quantity of accesses is defined by the prefetch policy in association with transferring metadata between the first tier of memory and the second tier of memory.

In some examples, the second tier of memory is associated with a lower access latency than the first tier of memory, a higher bandwidth than the first tier of memory, or a combination thereof.

In some examples, the first tier of memory includes a first type of non-volatile memory associated with a first access latency or a first type of volatile memory associated with a second access latency. In some examples, the second tier of memory includes a second type of non-volatile memory associated with a third access latency that is less than the first access latency or the second access latency or a second type of volatile memory associated with a fourth access latency that is less than the first access latency or the second access latency.

FIG. 5 shows a flowchart illustrating a method 500 that supports inter-tier metadata storage in accordance with examples as disclosed herein. The operations of method 500 may be implemented by a system or its components as described herein. For example, the operations of method 500 may be performed by a system (e.g., a memory system, a system that includes a memory system) as described with reference to FIGS. 1 through 4. In some examples, a system may execute a set of instructions to control the functional elements of the device to perform the described functions. Additionally, or alternatively, the system may perform aspects of the described functions using special-purpose hardware.

At 505, the method may include accessing, using a controller associated with a memory system, metadata stored in a first tier of memory of the memory system based on a command to access data associated with the metadata. The operations of 505 may be performed in accordance with examples as disclosed herein. In some examples, the system may include a controller 320 or 325 that may access metadata (e.g., a metadata 350-b) stored in a first tier of memory (e.g., a memory tier 345-b) of a memory system (e.g., a memory system 305-a) based on a command to access data associated with the metadata. In some examples, aspects of the operations of 505 may be performed by an access component 425 as described with reference to FIG. 4.

At 510, the method may include determining, based on accessing the metadata stored in the first tier of memory, whether a quantity of accesses of the metadata satisfies a threshold quantity of accesses. The operations of 510 may be performed in accordance with examples as disclosed herein. In some examples, the memory system may include the controller 320 or 325 that may determine, based on accessing the metadata stored in the first tier of memory, whether a quantity of accesses of the metadata satisfies a threshold quantity of accesses. In some examples, aspects of the operations of 510 may be performed by a threshold component 430 as described with reference to FIG. 4.

At 515, the method may include transferring the metadata to a second tier of memory of the memory system based on the quantity of accesses of the metadata satisfying the threshold quantity of accesses, where the first tier of memory associated with a first access latency is different from a second access latency associated with the second tier of memory. The operations of 515 may be performed in accordance with examples as disclosed herein. In some examples, the memory system may include a controller 320 or 325, a data mover, a memory controller 340, or a combination thereof that may transfer (e.g., facilitate the transfer of) the metadata (e.g., the metadata 350-b) from a first tier of memory (e.g., a memory tier 345-b) to a second tier of memory (e.g., a memory tier 345-a) of the memory system (e.g., the memory system 305-a) based on the quantity of accesses of the metadata satisfying the threshold quantity of accesses. In some examples, aspects of the operations of 515 may be performed by a transfer component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for accessing, using a controller associated with a memory system, metadata stored in a first tier of memory of the memory system based on a command to access data associated with the metadata; determining, based on accessing the metadata stored in the first tier of memory, whether a quantity of accesses of the metadata satisfies a threshold quantity of accesses; and transferring the metadata to a second tier of memory of the memory system based on the quantity of accesses of the metadata satisfying the threshold quantity of accesses, wherein the first tier of memory associated with a first access latency is different from a second access latency associated with the second tier of memory.

Aspect 2: The method, apparatus, or non-transitory computer-readable medium of aspect 1, further including operations, features, circuitry, logic, means, or instructions, or any combination thereof for receiving the command to access the data and accessing, based on the metadata being excluded from a metadata cache of the memory system, a metadata mapping indicating a location of the metadata within the memory system, where accessing the metadata stored in the first tier of memory of the memory system is based on accessing the metadata mapping.

Aspect 3: The method, apparatus, or non-transitory computer-readable medium of aspect 2, further including operations, features, circuitry, logic, means, or instructions, or any combination thereof for updating the metadata mapping to indicate a second location of the metadata within the second tier of memory based on transferring the metadata to the second tier of memory.

Aspect 4: The method, apparatus, or non-transitory computer-readable medium of any of aspects 2 through 3, where accessing the metadata includes operations, features, circuitry, logic, means, or instructions, or any combination thereof for reading the metadata to the metadata cache in accordance with a prefetch policy associated with the controller, where the threshold quantity of accesses is defined by the prefetch policy.

Aspect 5: The method, apparatus, or non-transitory computer-readable medium of any of aspects 1 through 4, further including operations, features, circuitry, logic, means, or instructions, or any combination thereof for adjusting, based on accessing the metadata, a value of a counter that tracks the quantity of accesses of the metadata, where the metadata is transferred to the second tier of memory based on the value of the counter satisfying the threshold quantity of accesses.

Aspect 6: The method, apparatus, or non-transitory computer-readable medium of aspect 5, where a respective counter is maintained for each entry of a metadata mapping indicating respective locations of respective metadata within the memory system.

Aspect 7: The method, apparatus, or non-transitory computer-readable medium of any of aspects 1 through 6, further including operations, features, circuitry, logic, means, or instructions, or any combination thereof for accessing, using the controller associated with the memory system, second metadata stored in a first tier of memory of a second memory system based on a command to access second data associated with the second metadata.

Aspect 8: The method, apparatus, or non-transitory computer-readable medium of any of aspects 1 through 7, further including operations, features, circuitry, logic, means, or instructions, or any combination thereof for determining that a second quantity of accesses of second metadata stored in the first tier of memory fails to satisfy a second threshold quantity of accesses and transferring the second metadata to a third tier of memory of the memory system based on the second quantity of accesses of the second metadata failing to satisfy the second threshold quantity of accesses.

Aspect 9: The method, apparatus, or non-transitory computer-readable medium of any of aspects 1 through 8, further including operations, features, circuitry, logic, means, or instructions, or any combination thereof for adjusting a value of a counter that tracks the quantity of accesses of the metadata and transferring the metadata from the first tier of memory to the second tier of memory or a third tier of memory of the memory system based on the adjusted value of the counter failing to satisfy the threshold quantity of accesses or a second threshold quantity of access.

Aspect 10: The method, apparatus, or non-transitory computer-readable medium of aspect 9, further including operations, features, circuitry, logic, means, or instructions, or any combination thereof for receiving, from a host system, a second command to adjust the value of the counter, where the value of the counter is adjusted based on the second command.

Aspect 11: The method, apparatus, or non-transitory computer-readable medium of any of aspects 9 through 10, where the value of the counter is adjusted periodically.

Aspect 12: The method, apparatus, or non-transitory computer-readable medium of any of aspects 9 through 11, where the value of the counter is adjusted by resetting the value of the counter, dividing the value of the counter by a second value, or decrementing the counter by a third value.

Aspect 13: The method, apparatus, or non-transitory computer-readable medium of any of aspects 1 through 12, where the controller is included in a switch associated with the memory system or the controller is included in the memory system.

Aspect 14: The method, apparatus, or non-transitory computer-readable medium of any of aspects 1 through 13, where a prefetch policy defines a plurality of a threshold quantity of accesses associated with transferring respective metadata between a plurality of tiers of memory of the memory system and the threshold quantity of accesses is defined by the prefetch policy in association with transferring metadata between the first tier of memory and the second tier of memory.

Aspect 15: The method, apparatus, or non-transitory computer-readable medium of any of aspects 1 through 14, where the second tier of memory is associated with a lower access latency than the first tier of memory, a higher bandwidth than the first tier of memory, or a combination thereof.

Aspect 16: The method, apparatus, or non-transitory computer-readable medium of any of aspects 1 through 15, where the first tier of memory includes a first type of non-volatile memory associated with a first access latency or a first type of volatile memory associated with a second access latency and the second tier of memory includes a second type of non-volatile memory associated with a third access latency that is less than the first access latency or the second access latency or a second type of volatile memory associated with a fourth access latency that is less than the first access latency or the second access latency.

It should be noted that the methods described herein describe possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 17: An apparatus, including: a first tier of memory associated with a first access latency; a second tier of memory associated with a second access latency different from the first access latency; and a controller coupled with the first tier of memory and the second tier of memory, the controller configured to transfer metadata between the first tier of memory and the second tier of memory based on whether a quantity of accesses of the metadata satisfies a threshold quantity of accesses.

Aspect 18: The apparatus of aspect 17, further including: a metadata mapping configured to store an indication of a location of the metadata within the apparatus, where the controller is configured to update the indication of the metadata mapping to indicate a second location of the metadata within the apparatus based on transferring the metadata between the first tier of memory and the second tier of memory.

Aspect 19: The apparatus of any of aspects 17 through 18, further including: a metadata cache coupled with the controller, where the controller is configured to transfer the metadata to the metadata cache based on a command to access data associated with the metadata, and where the quantity of accesses of the metadata is adjusted based on the command.

Aspect 20: The apparatus of any of aspects 17 through 19, further including: one or more counters configured to track respective quantities of accesses of respective metadata, where the controller is configured to transfer the metadata between the first tier of memory and the second tier of memory based on whether a value of a counter configured to track the quantity of accesses of the metadata satisfies the threshold quantity of accesses.

Aspect 21: The apparatus of aspect 20, where the controller is configured to adjust respective values of one or more of the one or more counters periodically or based on a command from a host system.

Aspect 22: The apparatus of any of aspects 17 through 21, further including: a plurality of tiers of memory including the first tier of memory and the second tier of memory, each tier of memory associated with a respective access latency, a respective bandwidth, or a combination thereof, where the controller is configured to transfer respective metadata between respective tiers of memory based on whether a respective quantity of accesses of the respective metadata satisfies a respective threshold quantity of accesses.

Aspect 23: The apparatus of any of aspects 17 through 22, where the first tier of memory and the second tier of memory are included in a memory system of the apparatus, and where: the controller is included in a switch associated with the memory system, or the controller is included in the memory system.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. At any given time, a conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other when the switch is open. When a controller isolates two components, the controller affects a change that prevents signals from flowing between the components using a conductive path that previously permitted signals to flow.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component (e.g., a transistor) discussed herein may represent a field-effect transistor (FET), and may comprise a three-terminal component including a source (e.g., a source terminal), a drain (e.g., a drain terminal), and a gate (e.g., a gate terminal). The terminals may be connected to other electronic components through conductive materials (e.g., metals, alloys). The source and drain may be conductive, and may comprise a doped (e.g., heavily-doped, degenerate) semiconductor region. The source and drain may be separated by a doped (e.g., lightly-doped) semiconductor region or channel. If the channel is n-type (e.g., majority carriers are electrons), then the FET may be referred to as a n-type FET. If the channel is p-type (e.g., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” when a voltage greater than or equal to the transistor's threshold voltage is applied to the transistor gate. The transistor may be “off” or “deactivated” when a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over as one or more instructions (e.g., code) on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and modules described in connection with the disclosure herein may be implemented or performed with a processor, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or any type of processor. A processor may also be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a computer, or a processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method, comprising:
accessing, using a controller associated with a memory system, metadata stored in a first tier of memory of the memory system based on a command to access data associated with the metadata;
determining, based on accessing the metadata stored in the first tier of memory, whether a quantity of accesses of the metadata satisfies a threshold quantity of accesses; and
transferring the metadata to a second tier of memory of the memory system based on the quantity of accesses of the metadata satisfying the threshold quantity of accesses, wherein the first tier of memory associated with a first access latency is different from a second access latency associated with the second tier of memory.

2. The method of claim 1, further comprising:
receiving the command to access the data; and
accessing, based on the metadata being excluded from a metadata cache of the memory system, a metadata mapping indicating a location of the metadata within the memory system, wherein accessing the metadata stored in the first tier of memory of the memory system is based on accessing the metadata mapping.

3. The method of claim 2, further comprising:
updating the metadata mapping to indicate a second location of the metadata within the second tier of memory based on transferring the metadata to the second tier of memory.

4. The method of claim 2, wherein accessing the metadata comprises:
reading the metadata to the metadata cache in accordance with a prefetch policy associated with the controller, wherein the threshold quantity of accesses is defined by the prefetch policy.

5. The method of claim 1, further comprising:
adjusting, based on accessing the metadata, a value of a counter that tracks the quantity of accesses of the metadata, wherein the metadata is transferred to the second tier of memory based on the value of the counter satisfying the threshold quantity of accesses.

6. The method of claim 5, wherein a respective counter is maintained for each entry of a metadata mapping indicating respective locations of respective metadata within the memory system.

7. The method of claim 1, further comprising:
accessing, using the controller associated with the memory system, second metadata stored in a first tier of memory of a second memory system based on a command to access second data associated with the second metadata.

8. The method of claim 1, further comprising:
determining that a second quantity of accesses of second metadata stored in the first tier of memory fails to satisfy a second threshold quantity of accesses; and
transferring the metadata to a third tier of memory of the memory system based on the second quantity of accesses of the second metadata failing to satisfy the second threshold quantity of accesses.

9. The method of claim 1, further comprising:
adjusting a value of a counter that tracks the quantity of accesses of the metadata; and
transferring the metadata from the first tier of memory to the second tier of memory or a third tier of memory of the memory system based on the adjusted value of the counter failing to satisfy the threshold quantity of accesses or a second threshold quantity of access.

10. The method of claim 9, wherein the value of the counter is adjusted by resetting the value of the counter, dividing the value of the counter by a second value, or decrementing the counter by a third value.

11. The method of claim 1, wherein:
a prefetch policy defines a plurality of a threshold quantity of accesses associated with transferring respective metadata between a plurality of tiers of memory of the memory system, and
the threshold quantity of accesses is defined by the prefetch policy in association with transferring metadata between the first tier of memory and the second tier of memory.

12. The method of claim 1, wherein:
the first tier of memory comprises a first type of non-volatile memory associated with a first access latency or a first type of volatile memory associated with a second access latency, and
the second tier of memory comprises a second type of non-volatile memory associated with a third access latency that is less than the first access latency or the second access latency or a second type of volatile memory associated with a fourth access latency that is less than the first access latency or the second access latency.

13. An apparatus, comprising:
a first tier of memory associated with a first access latency;
a second tier of memory associated with a second access latency different from the first access latency; and
a controller coupled with the first tier of memory and the second tier of memory, the controller configured to transfer metadata between the first tier of memory and the second tier of memory based on whether a quantity of accesses of the metadata satisfies a threshold quantity of accesses.

14. The apparatus of claim 13, further comprising:
a metadata mapping configured to store an indication of a location of the metadata within the apparatus, wherein the controller is configured to update the indication of the metadata mapping to indicate a second location of the metadata within the apparatus based on transferring the metadata between the first tier of memory and the second tier of memory.

15. The apparatus of claim 13, further comprising:
a metadata cache coupled with the controller, wherein the controller is configured to transfer the metadata to the metadata cache based on a command to access data associated with the metadata, and wherein the quantity of accesses of the metadata is adjusted based on the command.

16. The apparatus of claim 13, further comprising:
one or more counters configured to track respective quantities of accesses of respective metadata, wherein the controller is configured to transfer the metadata between the first tier of memory and the second tier of memory based on whether a value of a counter configured to track the quantity of accesses of the metadata satisfies the threshold quantity of accesses.

17. The apparatus of claim 16, wherein the controller is configured to adjust respective values of one or more of the one or more counters periodically or based on a command from a host system.

18. The apparatus of claim 13, further comprising:
a plurality of tiers of memory comprising the first tier of memory and the second tier of memory, each tier of memory associated with a respective access latency, a respective bandwidth, or a combination thereof,
wherein the controller is configured to transfer respective metadata between respective tiers of memory based on whether a respective quantity of accesses of the respective metadata satisfies a respective threshold quantity of accesses.

19. The apparatus of claim 13, wherein the first tier of memory and the second tier of memory are included in a memory system of the apparatus, and wherein:
the controller is included in a switch associated with the memory system, or
the controller is included in the memory system.

20. An apparatus, comprising:
a controller associated with a memory system, the controller configured to cause the apparatus to:
access, using the controller, metadata stored in a first tier of memory of the memory system based on a command to access data associated with the metadata;
determine, based on accessing the metadata stored in the first tier of memory, whether a quantity of accesses of the metadata satisfies a threshold quantity of accesses; and
transfer the metadata to a second tier of memory of the memory system based on the quantity of accesses of the metadata satisfying the threshold quantity of accesses, where the first tier of memory associated with a first access latency is different from a second access latency associated with the second tier of memory.
